(19) United States
(12) Patent Application Publication
(10) Pub. No.: US 2016/0076234 A1
(43) Pub. Date: Mar. 17, 2016

(54) MAGNETIC BAFFLE RING AND MAGNETIC BAFFLE FOR FOOD WASTE DISPOSER

(71) Applicant: Emerson Electric Co., St. Louis, MO (US)

(72) Inventors: Randall E. HAMMER, Muskego, WI (US); Kelly T. GAMBLE, Waterford, WI (US)

(73) Assignee: Emerson Electric Co., St. Louis, MO (US)

(21) Appl. No.: 14/818,631

(22) Filed: Aug. 5, 2015

Related U.S. Application Data
(60) Provisional application No. 62/051,367, filed on Sep. 17, 2014.

(51) Int. Cl. E03C 1/266; B02C 23/36; H01F 7/02

(52) U.S. Cl. CPC E03C 1/2665; H01F 7/021; B02C 23/36

(57) ABSTRACT

A magnetic baffle ring has a ring with a plurality of magnets disposed therein. A magnetic baffle has a baffle having an outer geometry that conforms to a sink drain opening. The baffle of the magnetic baffle has the magnetic baffle ring disposed therein.

### CROSS REFERENCE TO RELATED APPLICATIONS

This application claims the benefit of U.S. Provisional Application No. 62/051,367 filed on Sep. 17, 2014. The entire disclosure of the above application is incorporated herein by reference.

### FIELD

The present disclosure relates generally to food waste disposers, and more particularly, to a magnetic baffle ring for a food waste disposer baffle.

Food waste disposers are used to comminute food scraps into particles small enough to safely pass through household drain plumbing. A conventional food waste disposer of the type for under sink mounting that is mounted to a sink, such as a kitchen sink, includes a food conveying section, a motor section, and a central grinding section disposed between the food conveying section and the motor section. The food conveying section includes a housing that forms an inlet for receiving food waste and water. The food conveying section conveys the food waste to the grinding section, and the motor section includes a motor imparting rotational movement to a motor shaft to operate a grinding mechanism of the grinding section.

The grinding mechanism of the grinding section in which comminution occurs typically has a rotating shredder plate with lugs and a stationary grind ring received in a housing of the grinding section. The motor turns the rotating shredder plate and the lugs force the food waste against the grind ring where it is broken down into small pieces. Once the particles are small enough to pass out of the grinding mechanism, they are flushed out into the household plumbing. Size control is primarily achieved through controlling the size of the gap through which the food particles must pass. In some cases, the housing of the grinding section and the housing of the food conveying section are integrally formed as a single housing. In other cases, they are not. The food waste disposer may be mounted in a well-known manner in the drain opening of a sink using, for example, mounting members of the type disclosed in U.S. Pat. Pub. No. 2012/0256025, which is incorporated herein by reference in its entirety.

A baffle can be placed between the inlet of the food waste disposer and the drain opening of the sink, to keep food from being “kicked back” up through the drain opening when the food waste disposer is operating. The baffle for example can be placed in the drain opening, and may be a removable baffle. Such a baffle can also be, or alternatively be, a noise reducing baffle. One such noise reducing baffle is disclosed in U.S. Pat. No. 7,264,188, the entire disclosure of which is incorporated herein by reference. When the food waste disposer is mounted to a sink using the mounting members described in mounting members of the type disclosed in U.S. Pat. Pub. No. 2012/0256025, the baffle may be received in a sink flange of the type disclosed in US Pat. Pub. No. 2012/02566025 which is received in and extends through the drain opening of the sink.

One type of accessory that has been available for food waste disposers is known as a silverware saver, which is a device that has magnets and is mounted beneath the sink around the drain opening of the sink. The magnets attract silverware (knives, forks and spoons) made of ferromagnetic material that starts to fall through the drain opening of the sink and prevent them from falling into the food waste disposer. One type of silverware saver has two magnetic collar halves that are secured together beneath the sink around the drain opening of the sink and mounted to the sink with mounting brackets, and may for example be mounted around the sink flange where it exits the drain opening. Silverware savers that mount under the sink are limited to configurations that will match the outside contour of the sink surrounding the drain opening. Sinks with a radius contours are particularly difficult to attach this type silverware saver, which requires the use of fasteners and access to the underside of the sink.

### SUMMARY

This section provides a general summary of the disclosure, and is not a comprehensive disclosure of its full scope or all of its features.

In accordance with an aspect of the present disclosure, a magnetic baffle ring has a ring with a plurality of magnets disposed therein. In an aspect, a magnetic baffle has a baffle having an outer geometry that conforms to a sink drain opening. The baffle of the magnetic baffle has the magnetic baffle ring disposed therein.

In an aspect, the magnets are spaced equidistantly around the ring.

In an aspect, the magnetic baffle ring includes top and bottom plastic rings are configured to snap together to form the ring in which the plurality of magnets area disposed. In an aspect, each of the top and bottom rings include a plurality of pockets that when the top and bottom rings are mated together, the pockets of the top ring align with the pockets of the bottom ring to define magnet pockets in which the magnets are disposed.

In an aspect, the magnetic baffle ring is received around an outer side of the baffle. In an aspect, the ring has a diameter that is smaller than an outer diameter of the outer side of the baffle.

In an aspect, a top of the baffle is formed to have a folded over collar that defines a magnetic ring receiving cavity in which the magnetic baffle ring is received. In an aspect, the magnetic ring receiving cavity has a width that is less than a thickness of the ring.

In an aspect, a magnetic baffle ring is formed by ovemolding plastic around magnets to form a plastic ring. The ring is thus a plastic ring with plastic overmolded around the magnets forming overmolded magnets. In an aspect, the magnets are spaced equidistantly around the ring, a top of the baffle is formed to have a folded over collar that defines a magnetic ring receiving cavity in which the magnetic baffle ring is received, and the collar has a plurality of magnet receiving pockets therein which correspond to and receive the overmolded magnets.

In an aspect, a magnetic baffle includes a baffle having an outer geometry that conforms to a sink drain opening. The baffle is molded of a material that is molded around a plurality of magnets forming the magnetic baffle. The baffle has the plurality of magnets disposed therein with an overmold of material of which the baffle is molded around the magnets. In an aspect, the magnets are disposed equidistantly around the baffle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is perspective view of a magnetic baffle ring in accordance with an aspect of the present disclosure;

FIG. 2 is perspective view of a portion of the magnetic baffle ring of FIG. 1;

FIG. 3 is a perspective view of a plastic ring in accordance with an aspect of the present disclosure that snaps together with another such plastic ring to form a ring of the magnetic baffle ring of FIG. 1;

FIG. 4 is a section view of a baffle having the magnetic baffle ring of FIG. 1 affixed therein;

FIG. 5 is an expanded view of portion 5-5 of FIG. 4;

FIG. 6 is a perspective view of another magnetic baffle ring in accordance with an aspect of the present disclosure;

FIG. 7 is a perspective view of a baffle having the magnetic baffle ring of FIG. 6 affixed therein;

FIG. 8 is a perspective view of a baffle molded with magnets therein in accordance with an aspect of the present disclosure; and

FIG. 9 is an expanded view of portion 9-9 of FIG. 2.

### DETAILED DESCRIPTION

Example embodiments will now be described more fully with reference to the accompanying drawings. Corresponding reference numerals indicate corresponding parts throughout the several views of the drawings.

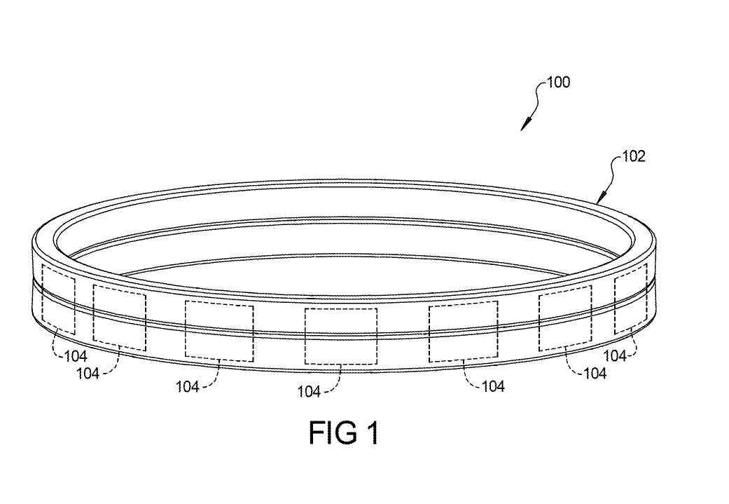

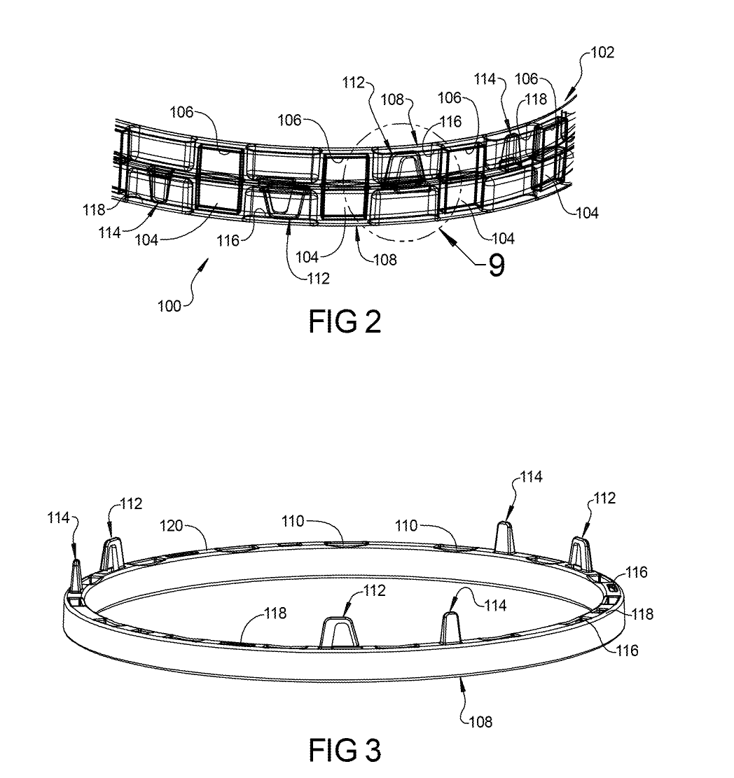

With reference to FIGS. 1-3, a magnetic baffle ring 100 in accordance with an aspect of the present disclosure is described. Magnetic baffle ring 100 includes a ring 102 in which a plurality of magnets 104 are disposed. In an aspect, magnets 104 are spaced equidistantly around ring 102 in magnet pockets 106 (FIG. 2) of ring 102.

In an aspect, ring 102 includes top and bottom plastic rings 108 (as oriented in FIG. 2), one of which is shown in FIG. 3, that are configured to snap together to form ring 102. Each ring 108 includes a plurality of pockets 110 (only some of which are identified by reference number 110 in FIG. 3) therein that when rings 108 are mated together, the pockets 110 of the top ring 108 align with corresponding pockets 110 of the bottom ring 108 to define magnet pockets 106. In an aspect, each magnet is a rare earth magnet, such as a neodymium magnet.

In the example shown in FIGS. 2 and 3, each of rings 108 includes a plurality of lock members 112 and a plurality of guide members 114. The lock members 112 are received in a plurality of corresponding lock pockets 116 in other ring 108 and the guide members 114 are received in a plurality of guide pockets 118 in the other ring 108. With further reference to FIG. 9, each lock member 112 and each guide member 114 project axially from a mating edge 120 of its ring 108. As best shown in FIG. 9, each lock member 112 has a resilient finger 122 that angles outwardly from an outer edge 123 of the lock member 112 having an end 126 that is spaced from mating edge 120 of the ring 108 having that lock member 112.

When the rings 108 are mated together, guide members 114 engaging guide pockets 118 guide the engagement of the two rings 108 with each other as they are brought together. As the two rings 108 are brought together, the lock members 112 of each ring 108 are received in the corresponding lock pockets 116 of the other ring 108. As the two rings 108 are fully brought together, each finger 122 snaps outwardly so that its end 126 engages a ledge 128 surrounding the lock pocket 116 in which that lock member 112 is received. It should be understood that ledge 128 is part of the ring 108 having the lock pocket 116 in which the lock member 112 is received.

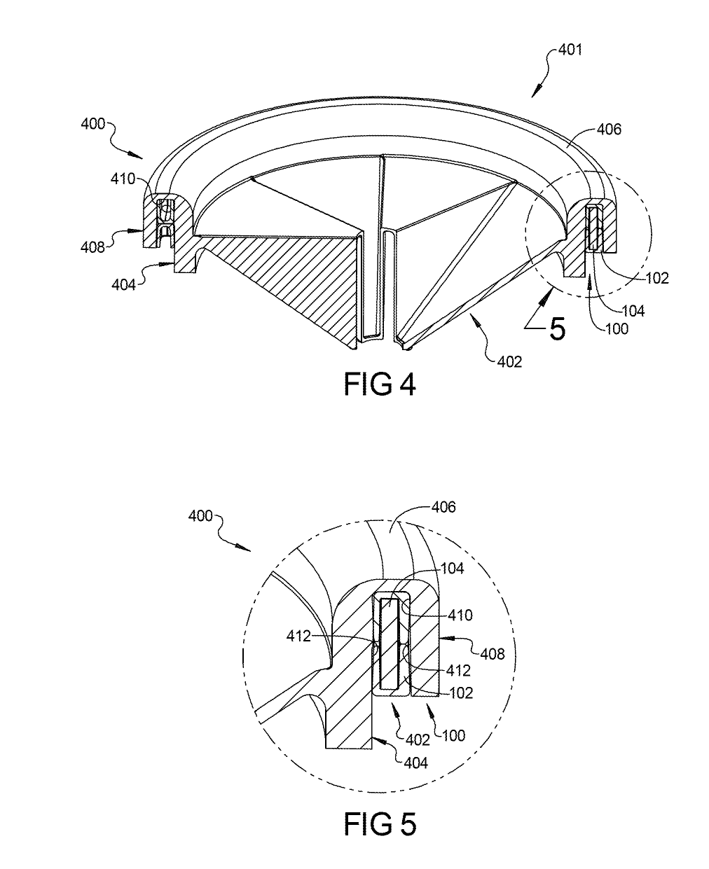

FIGS. 4 and 5 show magnetic baffle ring 100 affixed to a baffle 400 forming a magnetic baffle 401. Baffle 400 has an outer geometry that conforms to a sink drain opening which as used herein also means that if a sink flange is received in the sink drain opening, the outer geometry of the magnetic baffle 400 conforms to an opening in the sink flange where the sink flange is surrounded by the drain opening in which the sink flange is received. Magnetic baffle 401 (baffle 400 with magnetic baffle ring 100) would then be placed in a sink drain opening, such as in a sink flange received in the sink drain opening. Magnets 104 attract items made of ferromagnetic material, such as silverware made of ferromagnetic material, that fall into the sink drain to prevent the silverware from falling into the food waste disposer.

Illustratively, magnetic baffle ring 100 is slid into an underside 402 of baffle 400 and received around an outer side 404 of baffle 400 and held in place by friction. In this aspect, ring 102 has a diameter that is smaller, such as slightly smaller, than an outer diameter of outer side 404 of baffle 400.

In an aspect, a top 406 (as oriented in FIGS. 4 and 5) of baffle 400 is formed to have a folded over collar 408 that defines a ring receiving cavity 410 in which magnetic baffle ring 100 is received. In an aspect, ring receiving cavity 410 has a width that is less, such as slightly less, than a thickness of ring 102 of magnetic baffle ring 100 to hold ring 102 between opposed sides 412 (FIG. 5) of collar 408 by friction.

In an example embodiment, baffle 400 at top 406 has an outside diameter of 7.625 inches and an inside diameter of 6.031 inches. Ring 102 of magnetic baffle ring 100 is sized to fit in ring receiving cavity 410 between opposed sides 412 of collar 408. Ring 102 thus has an inside diameter somewhat greater than 6.031 inches and an outside diameter somewhat less than 7.625 inches. In an example, ring 102 has a height of about 0.866 inches and magnetic baffle ring 100 has fifteen magnets disposed equidistantly around ring 102 with each magnet being a 0.5 inch×0.75 inch×0.125 inch rectangular magnet.

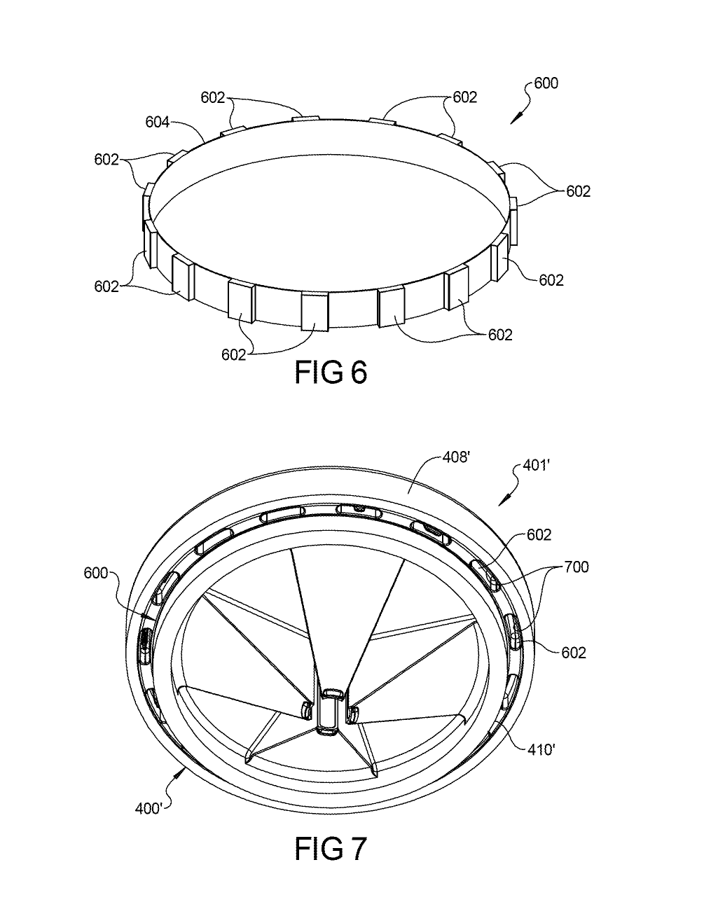

In an aspect, a magnetic baffle ring 600 (FIG. 6) has a plastic ring 604 with a plurality of magnets 104 embedded therein. Magnetic baffle ring 600 is illustratively formed by overmolding plastic around magnets 104 to form plastic ring 604 with magnets 104 embedded therein by an overmold of plastic around magnets 104 with magnetic baffle ring 600 thus having overmolded magnets 602. As used herein, overmolded magnets 602 are magnets 104 with the overmold of plastic therearound. Illustratively, overmolded magnets 602 are spaced equidistantly around plastic ring 604. In this aspect and with reference to FIG. 7, collar 408′ of baffle 400′ may be formed so that magnetic ring receiving cavity 410′ also has a plurality of spaced apart magnet receiving pockets 700 which correspond to and receive overmolded magnets 602 when magnetic baffle ring 600 is received in ring receiving cavity 410. For clarity, only some of overmolded magnets 602 and magnet receiving pockets 700 are identified with the reference numbers 602, 700 in FIG. 7. Baffle 400′ with magnetic baffle ring 600 received therein comprises a magnetic baffle 401′.

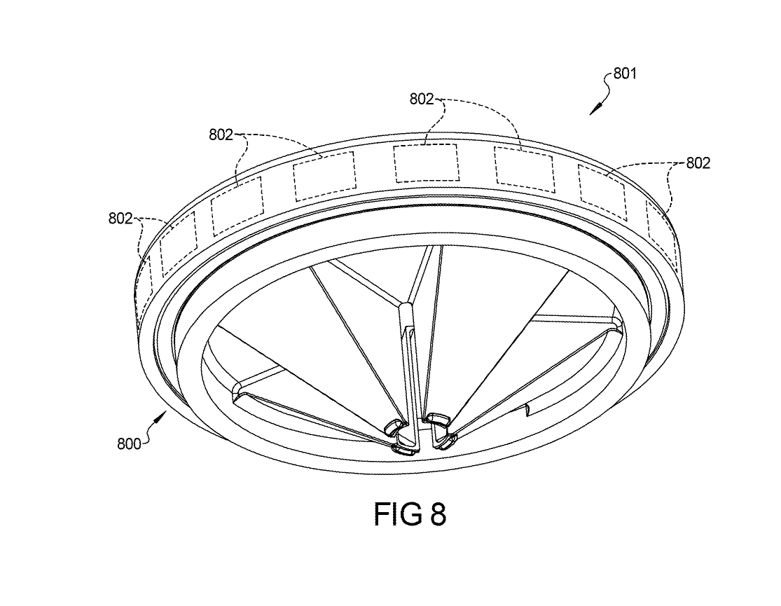

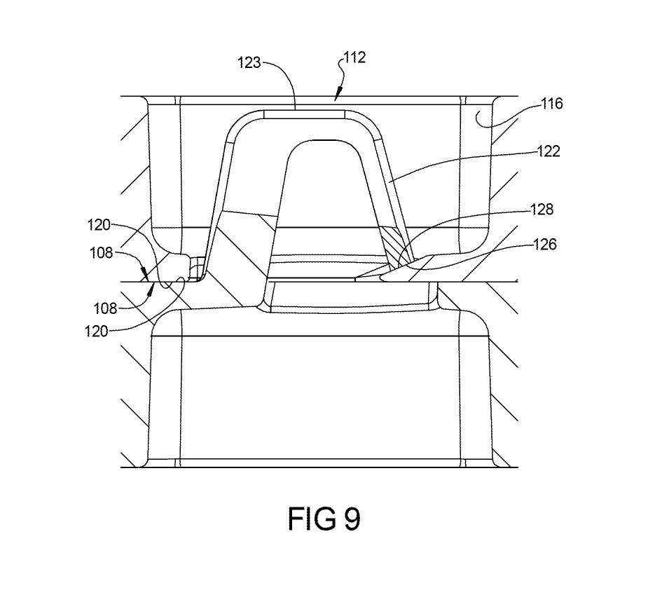

In an aspect and with reference to FIG. 8, baffle 800 is formed by molding it of a resilient material, illustratively a polymer, with magnets 802 in it forming magnetic baffle 801. Magnetic baffle 801 is thus a baffle of resilient material with magnets 802 embedded therein. For example, baffle 800 is formed by overmolding the material of which baffle 800 is molded around magnets 802. The magnets 802 are thus embedded in baffle 800 by an overmold of the resilient material of which the baffle 800 is molded around the magnets 802. The magnets 802 are spaced around the baffle 800, such as equidistantly around baffle 800.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A magnetic baffle, comprising:
a baffle having an outer geometry that conforms to a sink drain opening;
a magnetic baffle ring having a ring with a plurality of magnets disposed therein; and
the baffle having the magnetic baffle ring disposed therein.

2. The magnetic baffle of claim 1 wherein the magnets are spaced equidistantly around the ring.

3. The magnetic baffle of claim 1 wherein the ring includes top and bottom plastic rings configured to snap together.

4. The magnetic baffle of claim 3 wherein each of the top and bottom rings include a plurality of pockets that when the top and bottom rings are mated together, the pockets of the top ring align with the pockets of the bottom ring to define magnet pockets in which the magnets are disposed.

5. The magnetic baffle of claim 4 wherein the magnetic baffle ring is received around an outer side of the baffle.

6. The magnetic baffle of claim 5 wherein the ring has a diameter that is smaller than an outer diameter of the outer side of the baffle.

7. The magnetic baffle of claim 1 wherein a top of the baffle is formed to have a folded over collar that defines a magnetic ring receiving cavity in which the magnetic baffle ring is received.

8. The magnetic baffle of claim 7 wherein the magnetic ring receiving cavity has a width that is less than a thickness of the ring.

9. The magnetic baffle of claim 1 wherein the ring is a plastic ring with magnets embedded therein with the magnets and an overmold of plastic around the magnets comprising overmolded magnets.

10. The magnetic baffle of claim 9 wherein the magnets are spaced equidistantly around the ring, a top of the baffle is formed to have a folded over collar that defines a magnetic ring receiving cavity in which the magnetic baffle ring is received, and the collar has a plurality of magnet receiving pockets therein which correspond to and receive the overmolded magnets.

11. A magnetic baffle ring, comprising a ring with a plurality of magnets disposed therein.

12. The magnetic baffle ring of claim 11 wherein the magnets are spaced equidistantly around the ring.

13. The magnetic baffle ring of claim 11 wherein the ring includes top and bottom plastic rings configured to snap together to form the ring in which the plurality of magnets area disposed.

14. The magnetic baffle ring of claim 13 wherein each of the top and bottom rings include a plurality of pockets that when the top and bottom rings are mated together, the pockets of the top ring align with the pockets of the bottom ring to define magnet pockets in which the magnets are disposed.

15. The magnetic baffle ring of claim 14 wherein the ring has a diameter that is smaller than a diameter of an outer side of a baffle around which the ring is received.

16. The magnetic baffle ring of claim 11 wherein a thickness of the ring is greater than a width of a magnetic ring receiving cavity of a baffle in which the magnetic baffle ring is received.

17. The magnetic baffle ring of claim 11 wherein the ring is a plastic ring with magnets embedded therein with the magnets and an overmold of plastic around the magnets comprising overmolded magnets.

18. The magnetic baffle ring of claim 17 wherein the magnets are spaced equidistantly around the ring.

19. A magnetic baffle, comprising
a baffle of resilient material having a plurality of magnets embedded therein; and
the baffle having an outer geometry that conforms to a sink drain opening.

20. The magnetic baffle of claim 19 wherein the magnets are disposed equidistantly around the baffle.

21. The magnetic baffle of claim 19 wherein the baffle has an overmold of the resilient material around each of the magnets.
